(19) United States
(12) Patent Application Publication
(10) Pub. No.: US 2008/0055535 A1
(43) Pub. Date: Mar. 6, 2008

(54) TRANSPARENT DISPLAY

(75) Inventors: Toru Chiba, Tokyo (JP); Takaomi Sekiya, Tokyo (JP); Takanobu Shiokawa, Kanagawa (JP); Yukio Kubota, Saitama (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/754,436

(22) Filed: May 29, 2007

(30) Foreign Application Priority Data
May 30, 2006 (JP) 2006-150173

(51) Int. Cl. C09K 19/60

(52) U.S. Cl. 349/165

(57) ABSTRACT

A transparent display comprising a transmittance control block and a display block is provided. The transparent display transmits an optical image from a front surface to a back surface. The optical image is projected onto the front surface. A first image is displayed on the transparent display and superimposed onto the optical image. The transmittance control block is mounted to the front surface side. The transmittance control block comprises a guest-host liquid crystal layer and transparent electrodes. The transmittance of the light incident to the guest-host liquid crystal layer is able to be adjusted. The guest-host liquid crystal is mounted between the transparent electrodes. The display block is mounted to the back surface side. The display block comprises an organo-electroluminescence device. The first image is displayed on the display block.

### BACKGROUND OF THE INVENTION

1. Field of the Invention

A transparent display where a required image is superimposed on the optical image of an object projected from the back side.

2. Description of the Related Art

An organo-electroluminescence display, which is transparent, is known. The organo-electroluminescence display comprises transparent electrodes and a luminous layer which is placed between the transparent electrodes. An image desired to be superimposed on an optical image projected from the back side of the display is formed by ordering the luminous layer to emit light based on image data.

Incidentally, in a single lens reflex camera, the optical image of an object which is incident on an object lens is projected on a finder. In order to display desired information, such as an auto focus area, photometry, photographing conditions, and a captured image based on image data concurrently with the optical image projected from the backside, such an organo-electroluminescence display is mounted on the viewfinder of a single reflex camera.

In the transparent organo-electroluminescence display, the desired information is displayed by superimposition on an optical image projected from the backside. Consequently, it is difficult to distinguish the desired information from the entire optical image when the optical image is bright.

Regarding this problem, US Patent Publication No. 2005-0140813 discloses an organo-electroluminescence display combined with an electrochromic display or a liquid crystal display. The brightness of an optical image projected from the backside can be controlled by altering the transmittance of the electrochromic display or the liquid crystal display. However, for the electrochromic display, the rate of alteration of the transmittance is too slow to meet a required speed. As for the liquid crystal display, a dark optical image becomes darker and darker due to polarizing plates, which is necessary for the liquid crystal display.

### SUMMARY OF THE INVENTION

Therefore, an object of the present invention is to provide a transparent display wherein transmittance from the backside to the front side is controllable, the transmittance can be quickly changed, and a dark optical image projected from the backside can be displayed distinguishably.

According to the present invention, a transparent display comprising a transmittance control block and a display block is provided. The transparent display transmits an optical image from a front surface to a back surface. The optical image is projected onto the front surface. A first image is displayed on the transparent display and superimposed onto the optical image. The transmittance control block is mounted to the front surface side. The transmittance control block comprises a guest-host liquid crystal layer and transparent electrodes. The transmittance of the light incident to the guest-host liquid crystal layer is able to be adjusted. The guest-host liquid crystal is mounted between the transparent electrodes. The display block is mounted to the back surface side. The display block comprises an organo-electroluminescence device. The first image is displayed onto the display block.

Further, the guest-host liquid crystal layer is manufactured by adding dichromatic pigment to nematic liquid crystal.

Further, plural kinds of dichromatic pigment, of which the absorption bands of light are different to each other, are added to the guest-host liquid crystal layer.

### BRIEF DESCRIPTION OF THE DRAWINGS

The objects and advantages of the present invention will be better understood from the following description, with reference to the accompanying drawings in which:

FIG. 1 is a cross-sectional view showing the partial internal structure of a single lens reflex camera having a transparent display as an embodiment of the present invention;

FIG. 2 is a block diagram of the transparent display;

FIG. 3 is a first cross-sectional view showing the display panel in the thickness direction;

FIG. 4 is a rear view of the display panel to show the arrangement of the first transparent electrodes; and

FIG. 5 is a second cross-sectional view showing the display panel in the thickness direction.

### DESCRIPTION OF THE PREFERRED EMBODIMENTS

The present invention is described below with reference to the embodiments shown in the drawings.

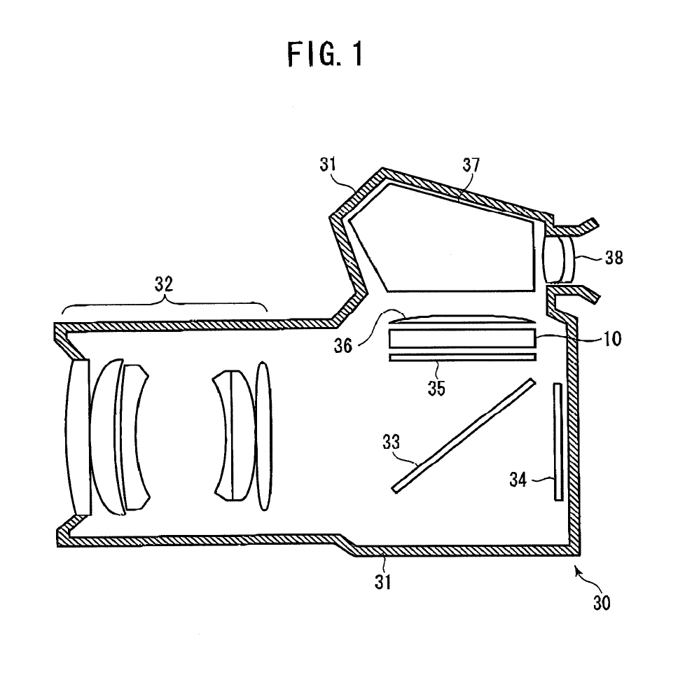

In FIG. 1, a single lens reflex camera 30 comprises a housing 31, a photographic optical system 32, a mirror 33, an imaging device 34, a focusing screen 35, a transparent display 10, a condenser lens 36, a pentaprism 37, and an eyepiece 38. Incidentally, in the FIG. 1, the direction from left to right is defined as the direction from the front to the back of the single lens reflex camera 30. The direction from top to bottom is defined as the direction from the top to the bottom of the single lens reflex camera 30.

The photographic optical system 32 comprises a plurality of lenses, such as a focusing lens and a zooming lens (not depicted). The mirror 33 is attached in the housing 31 so that the mirror 33 can rotate on a straight line perpendicular to the optical axis of the photographic optical system 32. Before and after the release operation, the mirror 33 is held in the path of the optical axis and the angle between the surface of the mirror 33 and the optical axis is held at 45 degrees.

The focusing screen 35, the transparent display 10, the condenser lens 36, and the pentaprism 37 are mounted above the mirror 33. The imaging device 34 is mounted behind the mirror 33. In addition, the eyepiece is mounted behind to the pentaprism 37.

Before and after the release operation, the optical image of an object passes through the photographic optical system 31 and is reflected by the mirror 33. The reflected optical image is focused on the focusing screen 35. The focused optical image passes through the focusing screen 35, the transparent display 10, the condenser lens 36, the pentaprism 37, and the eyepiece 38, and is then observable from the eyepiece 38.

When a release button (not depicted) is depressed, the release operation commences. In the release operation, the mirror 33 is raised, a shutter (not depicted) opens, and the imaging device 34 captures the optical image.

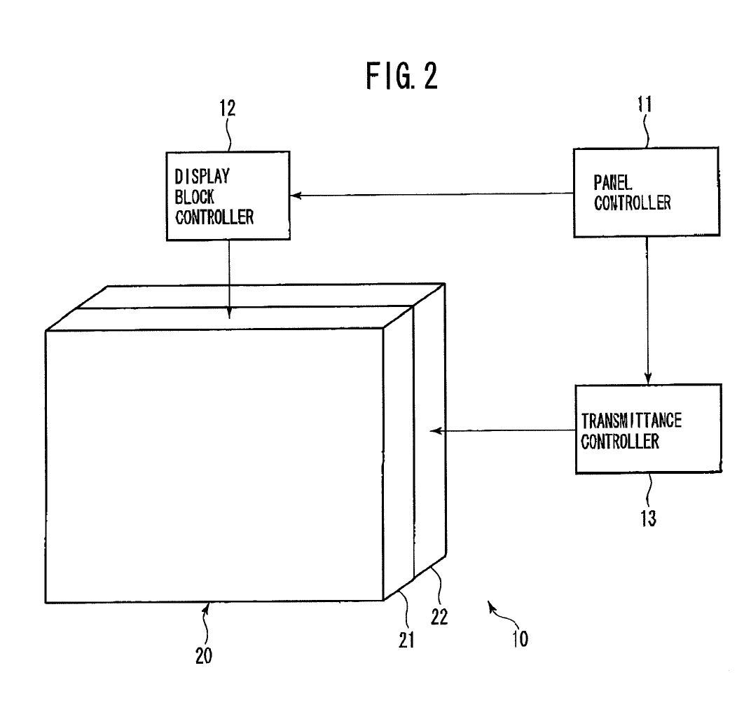

Next, the structure of the transparent display 10 is described below using FIG. 2. As shown in FIG. 2, the transparent display 10 comprises a display panel 20, a panel controller 11, a display block controller 12, and a transmittance controller 13.

The display panel 20 comprises a display plate 21 and a transmittance control plate 22, which are adhered to each other. The surfaces of the display panel 20 on the side of the display plate 21 and the side of the transmittance control plate 22 are determined as the back and front surfaces, respectively. Incidentally, an optical image projected on the display panel 20 and information desired to be superimposed on the optical image are observable from the back surface of the display panel 20.

The transparent display 10 receives display control data sent from an external apparatus (not depicted). The display control data is input to the panel controller 11. The panel controller converts the display control data into image data and transmittance control data. The image data is sent to the display block controller 12. The transmittance control data is sent to the transmittance controller 13.

The display block controller 12 controls the display plate 21 based on the received image data so that an image corresponding to the image data is displayed on the display plate 21.

The transmittance controller 13 controls the transmittance control plate 22 so that the transmittance of an optical image passing through the transmittance control plate 22 from the front surface to the back surface sustains a required transmittance corresponding to the received transmittance control data. Additionally, the transmittance is controlled based on the brightness of the object of which an optical image is incident to the photographic optical system 32. The single lens reflex camera 30 comprises a photometric sensor (not depicted) which detects the luminous quantity of the optical image. The transmittance of the transmittance control plate 22 is controlled so that the transmittance is decreased when the detected luminous quantity is great. In addition, the transmittance can be controlled according to a user's manual input to the input block (not depicted).

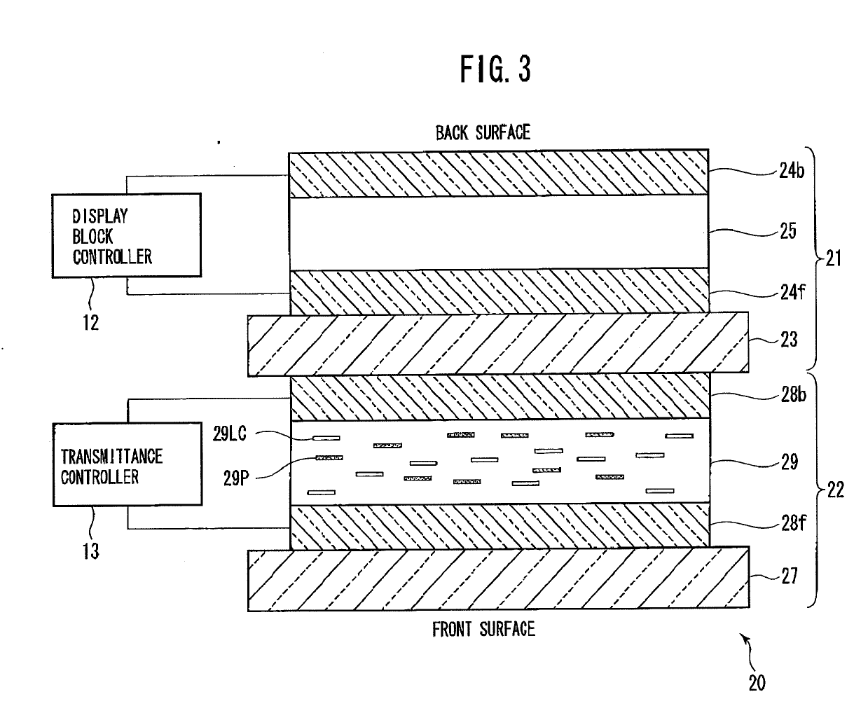

Next, the structure of the display panel 20 is described below using FIG. 3. As described above, the display panel 20 comprises a display plate 21 and a transmittance control plate 22.

The display plate 21 is an organo-electroluminescence device and comprises a glass substrate 23, first transparent electrodes 24f, 24b, and an organo-electroluminescence layer 25. In the display plate 21, the glass substrate 23, the first transparent electrodes 24f, the organo-electroluminescence layer 25, and the first transparent electrodes 24b are laminated together in that order from the front surface to the back surface. The organo-electroluminescence layer 25 comprises red, green, and blue luminous layers (not depicted), which emit red, green, and blue light, respectively, according to the current flowing between the first and second transparent electrodes 24f, 24b.

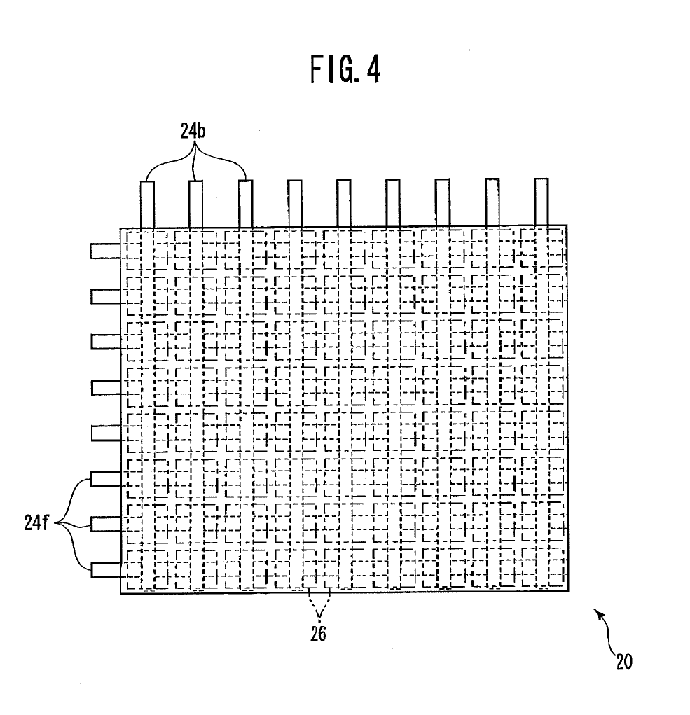

As shown in FIG. 4, a plurality of first transparent electrodes 24f on the front surface side are arranged so that each of the first transparent electrodes 24f are parallel lengthwise to the longer side of the display panel 20. A plurality of first transparent electrodes 24b on the back surface side are arranged so that each of the first transparent electrodes 24b are parallel lengthwise to the shorter side of the display panel 20.

A plurality of pixels 26 are formed at the area where the first transparent electrodes 24f, 24b intersect. By using the first transparent electrodes 24f on the front surface side and first transparent electrodes 24b on the back surface side for scanning and supplying the image data, respectively, different currents can be applied to different; pixel areas of the luminous layer. By applying current according to the amount of light required to be emitted at each pixel 26, a required color image can be displayed on the display plate 21.

The first transparent electrodes 24f, 24b are connected to the display block controller 12 (see FIG. 3). As described above, the display block controller 12 receives image data from the panel controller 11, and controls the flow of current between the first transparent electrodes 24f, 24b according to the received image data.

The transmittance control plate 22 comprises a glass substrate 27, second transparent electrodes 28f, 28b, and a guest-host liquid crystal layer 29. In the transmittance control plate 22, the glass substrate 27, the second transparent electrode 28f, the guest-host liquid crystal layer 29, and the second transparent electrode 28b are laminated together in that order from the front surface to the back surface. The guest-host liquid crystal layer 29 is manufactured by adding dichromatic pigment 29P to nematic liquid crystal in which a liquid crystal molecule 29LC is dispersed.

The dichromatic pigment 29P is a pigment which has absorption anisotropy, which has long, thin molecules, and of which the direction of the light absorption axis is substantially the same direction as the lengthwise direction of the molecule. Incidentally, plural kinds of dichromatic pigments 29P, of which the absorption bands of light are different to each other, are added to liquid crystal so that light within all visible light bands is absorbed equally.

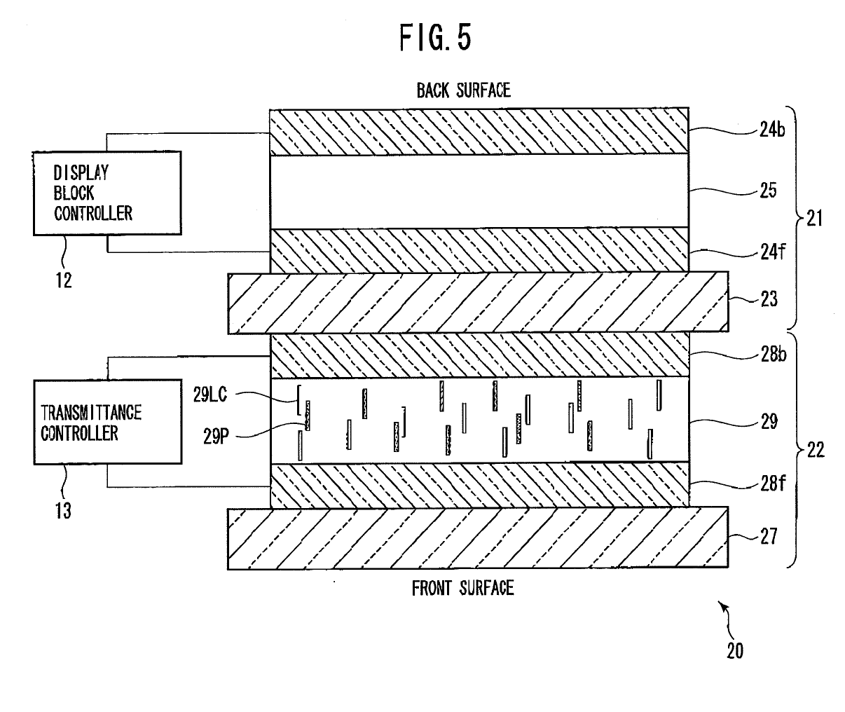

The dichromatic pigments 29P are arranged along the liquid crystal molecules 29LC around the dichromatic pigments 29P. Consequently, when a voltage is not applied to the guest-host liquid crystal layer 29, the dichromatic pigments 29P are arranged with the liquid crystal molecules 29LC in a direction perpendicular to the thickness direction of the guest-host liquid crystal layer 29 (see FIG. 3). When a voltage is applied to the guest-host liquid crystal layer 29, the dichromatic pigments 29P are arranged with the liquid crystal molecules 29LC in the thickness direction of the guest-host liquid crystal layer 29 (see FIG. 5).

As described above, the dichromatic pigments 20P have a light absorption axis of which the direction is substantially the same as the lengthwise direction of the molecules. Accordingly, the transmittance of light passing through the guest-host liquid crystal layer 29 increases as a voltage applied to the guest-host liquid crystal layer 29 increases. On the other hand, when a voltage is not applied to the guest-host liquid crystal layer 29, the transmittance of light becomes minimal. Consequently, the transmittance of an optical image projected from the front surface to the back surface can be controlled by controlling the voltage applied to the guest-host liquid crystal layer 29.

The second transparent electrodes 28f, 28b are connected to the transmittance controller 13. As described above, the transmittance controller 13 receives transmittance control data from the panel controller 11. The transmittance controller 13 controls the voltage applied between the second transparent electrodes 28f, 28b according to the received transmittance control data. Incidentally, the second transparent electrodes 28f, 28b are the same size as the display area of the display panel 20 and are formed in a plate shape parallel to the display panel 20. The voltage applied to the entire guest-host liquid crystal layer 29 is controlled.

According to the above embodiment, the maximum value of controlled transmittance is good enough, and it is possible to alter the transmittance of an optical image quickly. This is because the alternation speed of the transmittance of a guest-host liquid crystal is greater than that of an electrochromic display. In addition, the maximum value of the controlled transmittance can be good enough because a polarizing plate, which is necessary for a TN liquid crystal and causes the maximum transmittance to lower, is unnecessary for a guest-host liquid crystal.

In the above embodiment, the second transparent electrodes 28f, 28b are formed so that the size of the second transparent electrodes 28f, 28b is the same as the display area of the display panel 20. However, a plurality of the second transparent electrodes can be arranged on the guest-host liquid crystal layer 29 and each voltage applied between each combination of the second transparent electrodes 28f, 28b can be controlled. For example, the second transparent electrodes 28f, 28b can be shaped and arranged similarly to the first transparent electrodes 24f, 24b. If a plurality of second transparent electrodes 28f, 28b are arranged, by controlling each voltage applied to each area where the second transparent electrodes intersect, transmittance of each area which the display area of the display panel 20 is divided into can be controlled. For example, if an entire object is partially bright, the entire optical image projected to the transparent display 10 is observable by adjusting the transmittance of an area, where the optical image is partially bright, to be lower.

In addition, if a plurality of second transparent electrodes 28f, 28b are arranged, by controlling each voltage applied to each area where the second transparent electrodes intersect, a monochrome image can be formed on the guest-host liquid crystal layer 29. If a monochrome image is formed on the guest-host liquid crystal layer 29, the display plate does not function and the guest-host liquid crystal layer 29 controls the transmittance.

In the above embodiment, plural kinds of dichromatic pigments 29P, of which the absorption bands of light are different to each other, are used for the guest-host liquid crystal layer 29. However, only a singular kind of dichromatic pigment 29P can also be used. Of course, by using plural kinds of dichromatic pigments 29P, a projected optical image can be displayed on the transparent display 10 without changing the color of the original optical image.

In the above embodiment, the transmittance of the guest-host liquid crystal layer 29 increases in proportion to the voltage applied to the guest-host liquid crystal layer 29. However, the transmittance can also decrease in proportion to the voltage.

In the above embodiment, the display plate 21 is controlled according to the passive matrix method. However, the active matrix method is adaptable for use. Of course, if the active matrix method is used, it is preferable to use a transparent thin film transistor.

In the above embodiment, the first transparent electrodes 24f on the front surface side are arranged so that the first transparent electrodes 24f on the front side are parallel lengthwise to the longer side of the display panel 20 and the first transparent electrodes 24b on the back surface side are arranged so that the first transparent electrodes 24b on the back side are perpendicular to the first transparent electrodes 24f on the front surface side. However, any arrangement of the first transparent electrodes 24f, 24b is adaptable for use as long as the organo-electroluminescence layer 25 is mounted between the first transparent electrodes 24f, 24b.

In the above embodiment, the transparent display 10 is mounted in the single lens reflex camera 30. However, the transparent display 10 may be mounted in any kinds of camera. Furthermore, the transparent display 10 may be used for any apparatus, such as binoculars.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2006-150173 (filed on May 30, 2006), which is expressly incorporated herein, by reference, in its entirety.

1. A transparent display that transmits an optical image from a front surface to a back surface, said optical image being projected onto said front surface, a first image being displayed on said transparent display and superimposed onto an said optical image, said transparent display comprising:
a transmittance control block that is mounted to the front surface side and comprises a guest-host liquid crystal layer and transparent electrodes, the transmittance of the light incident to said guest-host liquid crystal layer being able to be adjusted, said guest-host liquid crystal layer being mounted between said transparent electrodes; and
a display block which is mounted to the back surface side, which comprises an organo-electroluminescence device, and onto which said first image is displayed.

2. A transparent display according to claim 1, wherein said guest-host liquid crystal layer is manufactured by adding dichromatic pigment to nematic liquid crystal.

3. A transparent display according to claim 1, wherein plural kinds of dichromatic pigment, of which the absorption bands of light are different to each other, are added to said guest-host liquid crystal layer.

4. A transparent display that transmits an optical image from a front surface to a back surface, said optical image being projected onto said front surface, a first image being displayed on said transparent display and superimposed onto said optical image, said transparent display comprising:
a transmittance control block that comprises a guest-host liquid crystal layer and a plurality of pairs of transparent electrodes facing each other, said guest-host liquid crystal layer being mounted between said pairs of said transparent electrodes, the transmittance of the light incident to said guest-host liquid crystal layer being able to be adjusted by a pair of said transparent electrodes, said first image being displayed by another pair of said transparent electrodes.
